(19) United States
(12) Patent Application Publication
(10) Pub. No.: US 2007/0011043 A1
(43) Pub. Date: Jan. 11, 2007

(54) Free multilevel marketing referral network

(76) Inventor: Jonathan Hendrik Van Ee, San Jose, CA (US)

Correspondence Address: Jonathan Hendrik Van Ee, 1055 N. Capitol Ave # 74, San Jose, CA, 95133, US

(21) Appl. No.: 11/175,711

(22) Filed: Jul. 6, 2005

(51) Int. Cl. G07G 1/14; G06Q 30/00

(52) U.S. Cl. 705/14

(57) ABSTRACT

This disclosure is about a free referral network that empowers consumers and businesses to benefit from referring people to the network. Producers, distributors, artists and other entities that create goods may be a part of the network by referring people to the network, by selling their goods through it, and by purchasing goods in the network. Sales people and consumers benefit by bringing quality goods to their friends and clients, and by obtaining a portion of the profits on sales to those people.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

Currently people have to pay, or otherwise generate a sale or other commercial benefit, to be a part of a referral network. The bottom line: something is required of people before they can become part of multilevel marketing organizations. This creates an issue for people with few resources, or for people who are not sure whether they would benefit from being a part of a multilevel marketing organization. People considering participation in a referral network must consider whether they are willing to take the risk to be a part of that network.

This creates a situation in which people are not building their networks to the fullest extent permitted by technology. Technology empowers the free flow of information in a manner not possible before. Generally speaking, people who have information about what products are available, and who may want to buy those products, have to make a substantial commitment to an existing multilevel marketing organization to benefit from that information. The free network described herein empowers those people to take advantage of their existing network of people they know. It also gives them an incentive to create a larger network. Significantly, the network allows people to benefit by simply referring other people who in turn know of other people who ultimately want to sell or buy goods. No multilevel marketing organization currently offers that service for free.

A free referral network is as radical a concept as free e mail was. A free referral network will unlock the power of human connections in a manner that has not been accomplished before. Businesses and consumers will benefit significantly as a result. This network will enable communities that organize around a shared interest, such as boating, to strengthen that community by referring quality products. People with solid information about what products are quality products can be rewarded financially for passing on that information.

Related organizations include Amway, Avon, and Mary Kay. There is also an association of multilevel marketing related organizations, which has its website at http://www.mlmia.com. None of those organizations offer free accounts from which a consumer can obtain cash for referring people, or for making a sale.

### BRIEF SUMMARY OF THE INVENTION

The free network will pay cash consumers, sales people, producers of goods, and other entities in commerce that cause the sale of goods. People will not be charged a fee for being part of the, network, but they will be paid money when they cause a sale to happen through the network. The network will be sustained by retaining a percentage of the profits from each sale.

### BRIEF DESCRIPTION OF THE SEVERAL VIEWS OF THE DRAWING

Not applicable.

### DETAILED DESCRIPTION OF THE INVENTION

The Free Multilevel Marketing Referral Network will enable people to create an account through which they can sell or purchase goods, or through which they can simply refer other people. The accounts can be created by people who produce goods, by people who sell goods professionally (like sales agents or distributors), by consumers who buy the goods themselves, or by anyone that wants to refer other people to the network.

The accounts of those referred people will be connected to the referring person's account. When a sale occurs because of a purchase made by the referred person, or because of a purchase that was brought about by the referred person (i.e., a sale caused by another person referred by the referred person), then each person who referred someone will get a certain sum of cash.

For example, person A is a consumer who joins the network on his own. He refers person B to the network, and person B in turn refers person C. If person C purchases a product from the network, then A and B will get a portion of the proceeds from such purchase.

Continuing the above example, suppose person X is a producer of artwork. Person X joins the network on his own, and person C purchases a piece of such artwork. Persons A, B and X would each get a portion of the sale.

The network would not charge a fee for people to be a part of the network. It would only charge a fee when a sale occurs (although producers of goods could be charged a fee for the costs of making their goods available in the network). The network could also earn income through advertising and charge a fee for premium service. But, the basic service of connecting the referral network is free.

The free nature of the network distinguishes it from other referral networks, like Amway and companies that sell beauty products. There is no subscription charge, and no minimum purchase necessary. This is possible because of the automated nature of the service and because the service supports itself from actual sales.

The levels to which the referring persons would obtain compensation from people they refer would be limited. For example, if in the above example person C referred person D, who in turn referred person E to the network, it would be possible for person A to not earn money on sales to person E.

Software can enable the Network to allow people to have free membership in the network. Established businesses can sell through the network because their goods can be displayed with software.

I claim the multilevel marketing referral network will:

1) Enable referral networks, and create new referral networks, by providing a free service that pays cash directly to the persons that create value for the network. It will empower decision makers in commerce from the consumer level to large organizations, by paying them cash for referrals through a free service. A wide variety of goods and services could be sold through the network.

2) Create or expand referral sales outlets for producers of products that do not have the resources to create a sales outlet themselves. It will allow those producers to spend more time refining and producing their product by giving them a sales organization.

3) Strengthen communities by giving a monetary value, for free, to the relationships in them. The network will make it pay for someone to give good advice to a friend about what products to buy.

4) Empower non profits, and other community based organizations, to raise support through those communities in an effective, efficient, and profitable way. Those organizations can refer their communities to the network and benefit from the sales made through the network.
